(19) United States
(12) Patent Application Publication
(10) Pub. No.: US 2014/0283528 A1
(43) Pub. Date: Sep. 25, 2014

(54) Aftertreatment Module and Method of Assembly

(71) Applicant: CATERPILLAR INC., Peoria, IL (US)

(72) Inventors: Andrew M. Denis, Peoria, IL (US); Mirza P. Baig, Peoria, IL (US); Nilkanth N. Desai, Dunlap, IL (US); Rick E. Jeffs, Peoria, IL (US); Kristian N. Engelsen, South Bend, IN (US); Pradyumna V. Rao, Peoria, IL (US); Ian Aguirre, Peoria, IL (US)

(73) Assignee: Caterpillar Inc., Peoria, IL (US)

(21) Appl. No.: 13/849,180

(22) Filed: Mar. 22, 2013

(51) Int. Cl. F02C 7/20

(52) U.S. Cl. CPC F02C 7/20
USPC 60/796; 29/890

(57) ABSTRACT

To assemble an aftertreatment module for use in the treatment of exhaust gasses and the like, an aftertreatment brick is inserted into a sleeve opening in a sleeve and advanced toward an opposite end of the sleeve. To retain the aftertreatment brick in the sleeve, the end of the sleeve can include a stop flange and the aftertreatment brick can include a mantle flange. The stop flange and the mantle flange can abut against each other to prevent further movement of the aftertreatment brick through the sleeve. To seal against exhaust gasses leaking though the module, a gasket can be disposed between the stop flange and the mantle flange. Exterior ribs disposed around the aftertreatment brick can assist concentric alignment between the flanges and gasket.

### TECHNICAL FIELD

This patent disclosure relates generally to an aftertreatment system for reducing emissions in exhaust gasses from a combustion process and, more particularly, to an aftertreatment module for such a system assembled from one or more aftertreatment bricks.

### BACKGROUND

Power systems such as, for example, large internal combustion engines burn hydrocarbon-based fuels or similar fuel sources to convert the chemical energy therein to mechanical energy that can be utilized to power an associated machine or application. Combustion of the hydrocarbon fuel may release or create several byproducts or emissions, such as nitrogen oxides (NO_{X}), carbon monoxides and carbon dioxides (CO and CO₂), and particulate matter. The quantity of some of these emissions that may be released to the environment may be subject to government regulations and environmental laws. Accordingly, manufacturers of such power systems may equip the system with an associated aftertreatment system to treat the emissions before they are discharged to the environment.

The aftertreatment system can be disposed in the exhaust channel of the power system and may include a unit or module through which the exhaust gasses may pass. The module may include one or more aftertreatment bricks that can change, chemically or physically, the composition of the exhaust gasses that encounter the bricks. Examples of aftertreatment bricks include catalysts that chemically alter the exhaust gasses and filters that can trap specific components of the exhaust gasses. Because the aftertreatment bricks may become depleted or deactivated after a period of use, or may become damaged due to the conditions in which they are used, and require replacement, in some aftertreatment systems the aftertreatment bricks may be removable. Inclusion of a plurality of bricks in the system may complicate their removability.

An example of a system using multiple, removable aftertreatment bricks, in particular catalysts, is described in U.S. Pat. No. 8,062,602 (the '602 patent). The '602 patent describes a pair of catalysts members disposed across the cross-section of an exhaust channel so as to be arranged perpendicularly to the exhaust flow. The catalysts members include rings that align with each other and with a sealing gasket disposed between the aligned rings to form sealing surfaces between the catalysts. Further, the rings may mate with sealing surfaces on the housing to prevent the escape of exhaust gas. However, to remove a catalyst member for replacement, access to the catalyst member must be achieved through an access door at a different location of the housing body that is perpendicular to the exhaust flow. This arrangement complicates removal of the catalyst members and makes accurate alignment of the rings and sealing surfaces difficult.

### SUMMARY

The disclosure describes, in one aspect, an aftertreatment module for treating exhaust gasses from an internal combustion process. The module can include one or more sleeves in a sleeve bundle. Each sleeve extends between a first end and a second end to delineate a sleeve axis. The first end includes a stop flange generally perpendicular to the sleeve axis and the second end includes an opening through which the sleeve axis can protrude. An aftertreatment brick can be axially inserted into the sleeve through the opening. The aftertreatment brick may include a substrate matrix and a mantle disposed around the substrate matrix. To align and abut the stop flange, the mantle can include a corresponding mantle flange and an exterior rib configured to contact an interior surface of the sleeve. A gasket can be disposed between the stop flange and the mantle flange.

In another aspect, the disclosure describes a method of assembling an aftertreatment module. According to the method, a sleeve is provided with a first end and a second end disposed along a sleeve axis. The first end includes a stop flange oriented perpendicular to the sleeve axis and the second end includes an opening. A gasket can be disposed inside the sleeve proximate to the stop flange. The method further provides an aftertreatment brick having a substrate matrix and a mantle disposed around the substrate matrix that includes a mantle flange. The aftertreatment brick can be inserted through the opening in the second end and toward the first end of the sleeve. The mantle flange can abut against the stop flange to prevent the aftertreatment brick from passing through the second end.

In yet another aspect, the disclosure describes an aftertreatment brick having a cylindrical substrate matrix delineating a brick axis and a tubular mantle disposed around the cylindrical substrate matrix concentric to the brick axis. An exterior rib can circumscribe the tubular mantle and is adapted to contact an interior surface of a tubular sleeve to concentrically align the aftertreatment brick with respect to the sleeve.

### BRIEF DESCRIPTION OF THE DRAWINGS

FIG. 1 is a side elevational view of a power system including an internal combustion engine coupled to a generator and associated with an aftertreatment module.

FIG. 2 is a perspective view of the clean emissions module with the top removed to illustrate the components inside of, and exhaust flow through, the module.

FIG. 3 is a perspective view of an aftertreatment module disposed in the clean emissions module, the aftertreatment module including at least one sleeve axially receiving a plurality of aftertreatment bricks.

FIG. 4 is a cross-sectional view illustrating the plurality of aftertreatment bricks retained in the sleeve between a stop flange and a retention mechanism.

FIG. 5 is a perspective view of an embodiment of an aftertreatment brick, in particular, a selective catalytic reduction catalyst, having a mantle disposed around a substrate matrix with the substrate matrix illustrated in detail.

FIG. 6 is a front elevational view of a gasket for inclusion between the stop flange and the aftertreatment brick.

### DETAILED DESCRIPTION

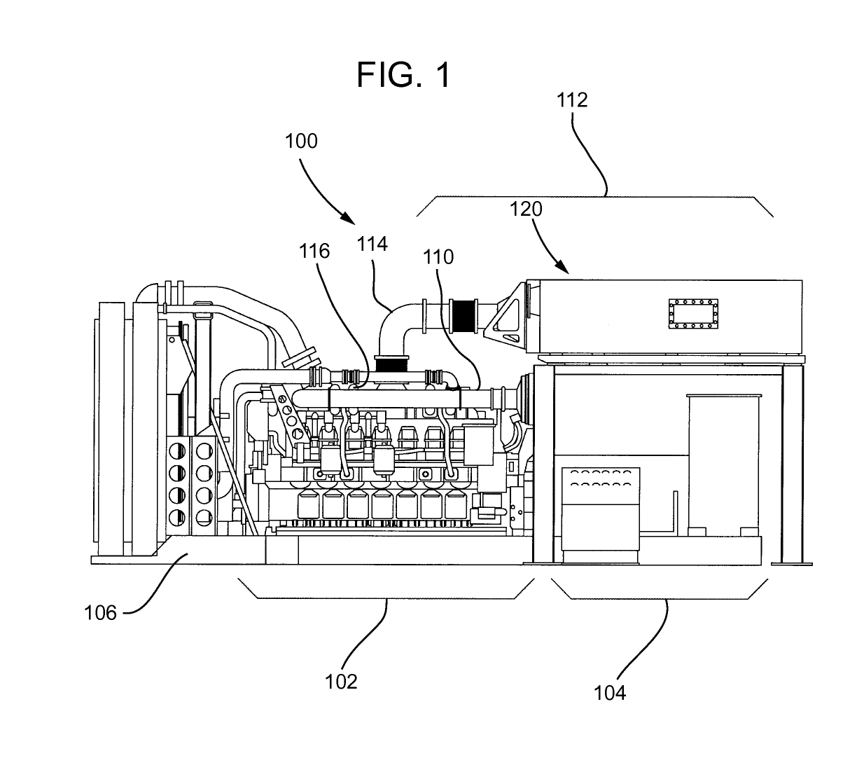

This disclosure relates generally to an exhaust aftertreatment system that may be associated with a power system producing exhaust gasses and, more particularly, relates to aftertreatment bricks that may be a removable component of such aftertreatment systems. Now referring to the drawings, wherein like reference numbers refer to like elements, there is illustrated in FIG. 1 an example of a power system 100 that can generate power by combusting fossil fuels or the like. The illustrated power system 100 can include an internal combustion engine 102 such as a diesel engine operatively coupled to a generator 104 for producing electricity. The internal combustion engine 102 may have any number of cylinders as may be appreciated by one of ordinary skill in the art. The internal combustion engine 102 and the generator 104 can be supported on a common mounting frame 106. The power system 100 can provide on-site stand-by power or continuous electrical power at locations where access to an electrical grid is limited or unavailable. Accordingly, the generator 104 and internal combustion engine 102 can be scaled or sized to provide suitable wattage and horsepower. It should be appreciated that in other embodiments, the power system of the present disclosure can be utilized in other applications such as gasoline burning engines, natural gas turbines, and coal burning systems. Further, in addition to stationary applications, the present disclosure can be utilized in mobile applications such as locomotives and marine engines.

To direct intake air into and exhaust gasses from the power system 100, the power system can include an air introduction system 110 and an exhaust system 112. The air introduction system 110 introduces air or an air/fuel mixture to the combustion chambers of the internal combustion engine 102 for combustion while the exhaust system 112 includes an exhaust pipe or exhaust channel 114 in fluid communication with the combustion chambers to direct the exhaust gasses produced by the combustion process to the environment. To pressurize intake air by utilizing the positive pressure of the expelled exhaust gasses, the power system 100 can include one or more turbochargers 116 operatively associated with the air introduction system 110 and the exhaust system 112.

The exhaust system 112 can include components to condition or treat the exhaust gasses before they are discharged to the environment. For example, an exhaust aftertreatment system 120 in the form of a clean emissions module (CEM) can be disposed in fluid communication with the exhaust system 112 downstream of the turbochargers 116 to receive the exhaust gasses discharged from the internal combustion engine 102. The term “aftertreatment” refers to the fact that the system treats exhaust gasses after they have been produced and is therefore distinguishable from fuel additives and the like that affect the combustion process. The aftertreatment system 120 can be designed as a separate unit that can be mounted to the power system 100 generally over the generator 104, for example, and can receive exhaust gasses from the exhaust channel 114. By manufacturing the aftertreatment system 120 as a separate modular unit, the design can be utilized with different sizes and configurations of the power system 100. However, in other embodiments, the aftertreatment system 120 can be integral with the power system 100 and can be disposed at other locations rather than above the power system. The aftertreatment system 120 can be configured to treat, remove or convert regulated emissions and other constituents in the exhaust gasses.

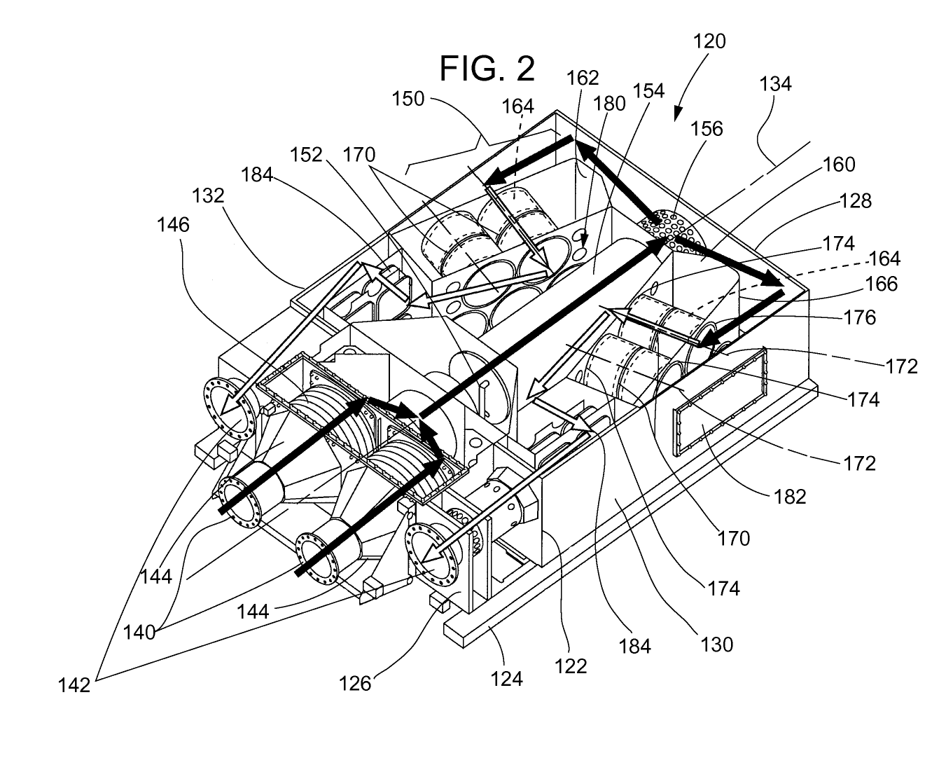

Referring to FIG. 2, the aftertreatment system 120 can include a box-like housing 122 that is supported on a base support 124 adapted to mount the aftertreatment system to the power system. The box-like housing 122 can include a forward-directed first wall 126, an opposing rearward second wall 128, and respective third and fourth sidewalls 130, 132. However, it should be appreciated that terms like forward, rearward and side are used only for orientation purposes and should not be construed as a limitation on the claims. Additionally, extending between the forward first wall 126 and rearward second wall 128 and located midway between the third and fourth sidewalls 130, 132 can be an imaginary central system axis line 134. The housing 122 may be made from welded steel plates or sheet material.

To receive the untreated exhaust gasses into the aftertreatment system 120, one or more inlets 140 can be disposed through the first wall 126 of the housing 122 and can be coupled in fluid communication to the exhaust channel from the exhaust system. In the embodiment illustrated, the aftertreatment system 120 includes two inlets 140 arranged generally in parallel and centrally located between the third and fourth sidewalls 130, 132 on either side of the system axis line 134 so that the entering exhaust gasses are directed toward the rearward second wall 128. However, other embodiments of the aftertreatment system 120 may include different numbers and/or locations for the inlets. To enable the exhaust gasses to exit the aftertreatment system 120, two outlets 142 can also be disposed through the first wall 126 of the housing 122. Each outlet 142 can be parallel to the centrally oriented inlets 140 and can be disposed toward one of the respective third and fourth sidewalls 130, 132.

To treat or condition the exhaust gasses, the housing 122 can contain various types or kinds of exhaust treatment devices through or past which the exhaust gasses are directed. For example and following the arrows indicating exhaust flow through the aftertreatment system 120, in order to slow the velocity of the incoming exhaust gasses for treatment, the inlets 140 can each be communicatively associated with an expanding, cone-shaped diffuser 144 mounted exteriorly of the front first wall 126. Each diffuser 144 can direct the exhaust gasses to an associated diesel oxidation catalyst (DOC) 146 located proximate the first wall 126 inside the housing 122 that then directs the exhaust gasses to a common collector duct 148 centrally aligned along the system axis line 134. The DOC 146 can contain materials such as platinum group metals like platinum or palladium which can catalyze carbon monoxide and hydrocarbons in the exhaust gasses to water and carbon dioxide via the following possible reactions:

CO+½ O₂=CO₂ (1)

[HC]+O₂=CO₂+H₂O (2)

To further reduce emissions in the exhaust gasses and, particularly, to reduce nitrogen oxides such as NO and NO₂, sometimes referred to as NO_{X}, the aftertreatment system may include an SCR system 150. In the SCR process, a liquid or gaseous reductant agent is introduced to the exhaust system and directed through an SCR catalyst along with the exhaust gasses. The SCR catalyst can include materials that cause the exhaust gasses to react with the reductant agent to convert the NO_{X} to nitrogen (N₂) and water (H₂O). A common reductant agent is urea ((NH₂)₂CO), though other suitable substances such as ammonia (NH₃) can be used in the SCR process. The reaction may occur according to the following general formula:

NH₃+NO_{X}=N₂+H₂O (3)

Referring to FIG. 2, to introduce the reductant agent, the SCR system 150 includes a reductant injector 152 located downstream of the collector duct 148 and upstream of a centrally aligned mixing duct 154 that channels the exhaust gasses toward the rearward second wall 128 of the housing 122. The reductant injector 152 can be in fluid communication with a storage tank or reservoir storing the reductant agent and can periodically, or continuously, inject a measure of the reductant agent into the exhaust gas stream in a process sometimes referred to as dosing. The amount of reductant agent introduced can be dependent upon the NO_{X} load of the exhaust gasses. The elongated mixing duct 154 uniformly intermixes the reductant agent with the exhaust gasses before they enter the downstream SCR catalysts. Disposed at the end of the mixing duct 154 proximate the second wall 128 can be a diffuser 156 that redirects the exhaust gas/reductant agent mixture toward the third and fourth sidewalls 130, 132 of the aftertreatment system 120. The third and fourth sidewalls 130, 132 can redirect the exhaust gas/reductant agent mixture generally back towards the front first wall 126.

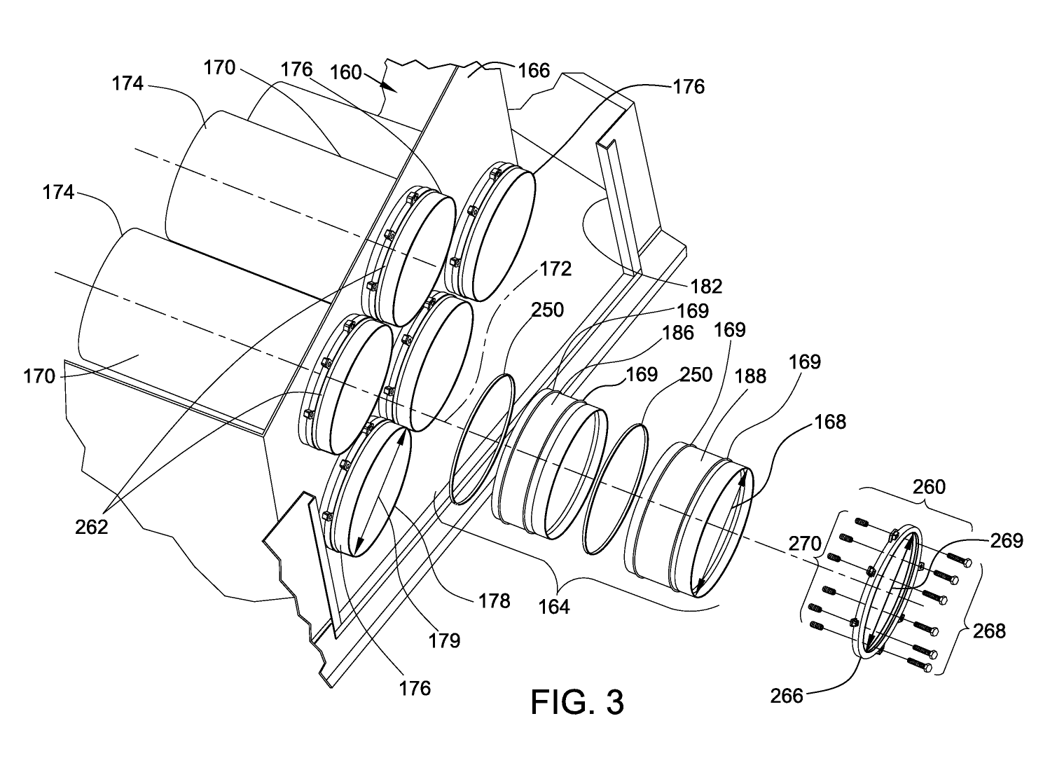

To perform the SCR reaction process, the aftertreatment system 120 can include a first SCR module 160 disposed proximate the third sidewall 130 and a second SCR module 162 disposed toward the fourth sidewall 132. The first and second SCR modules 160, 162 are oriented to receive the redirected exhaust gas/reductant agent mixture. Referring to FIGS. 2 and 3, the first and second SCR modules 160, 162 include a support structure or frame 166 that can accommodate one or more SCR catalysts 164 (of which only mantles but not substrates appear in FIG. 3), sometimes referred to as aftertreatment bricks. The term aftertreatment brick, however, may refer to a variety of exhaust aftertreatment devices which SCR catalysts are a subset of. Accordingly, in other embodiments, different types of aftertreatment bricks operating by different reaction processes may be substituted in the first and second SCR modules 160, 162. Further, although the illustrated plurality of SCR catalysts 164 are generally cylindrical and have an outer brick diameter or catalyst diameter 168, the SCR modules 160, 162 may be configured to accommodate aftertreatment bricks of different shapes, sizes and/or configurations. Accordingly, the described embodiments of aftertreatment bricks are by way of example only and should not be construed as limitations on the claims unless clearly stated otherwise.

To hold the plurality of SCR catalysts 164, the SCR modules 160, 162 can include one or more sleeves 170 that can slidably receive the catalysts. The sleeves 170 can be generally elongated, hollow tubular structures having a first end 174 and an opposing second end 176 aligned along a longitudinal sleeve axis 172. In some embodiments, the first end 174 can be designated a downstream end and the second end 176 can be designated an upstream end thereby establishing the direction of gas flow through the sleeve 170. In other embodiments, the system may be at least partially reversible so that either of the first and second ends may act as an upstream or downstream end. In those embodiments that include more than one sleeve 170 in the first and second SCR modules 160, 162, the sleeves can be supported in the truss-like frame 166 made, for example, from formed sheet metal or cast materials. The frame 166 can be oriented so that the first ends 174 communicate with a central region 180 of the aftertreatment system 120 and the second ends 176 are directed toward the respective third and fourth sidewalls 130, 132. The second ends 176 may protrude or extend from the frame 166 so that a portion of the exterior of the sleeve 170 is exposed. To access the first and second SCR modules 160, 162, for example to retrieve and replace the plurality of SCR catalysts 164, one or more access panels 182 can be disposed in the respective third and fourth sidewalls 130, 132 positioned toward the modules. The central region 180 can direct the received exhaust gasses forward to the outlets 142 disposed through the front first wall 126. In various embodiments, one or more additional exhaust treatment devices can be disposed in the aftertreatment system 120 such as diesel particulate filters 184 for removing soot.

Referring to FIG. 3, to enable the tubular sleeves 170 to receive the plurality of SCR catalysts 164, the second end 176 of each sleeve can delineate an opening 178 through which the catalysts can be inserted. The sleeve 170 and the plurality of SCR catalysts 164 can have complementary circular or cylindrical shapes, although in other embodiments, other shapes are contemplated. To provide a clearance fit to enable insertion, the opening 178 can have a first width dimension, more specifically a sleeve diameter 179, that is slightly larger than a second cross-sectional dimension associated with the plurality of SCR catalysts 164 such as the catalyst diameter 168. The dimensions of the catalyst diameter 168 and the sleeve diameter 179 can be sized to provide a 2-3 millimeter gap, for example, between portions of the catalysts and the sleeve 170. Therefore, to prevent leakage of the exhaust gasses/reductant agent mixture between the plurality of SCR catalysts 164 and the sleeve 170, the two components can be adapted to form a sealing engagement with each other. For example, one or more circular exterior ribs 169 can protrude radially about the circumference of each of the plurality of SCR catalysts 164 and form a seal or slight interference fit with the inner surface of the sleeves 170. Due to the complementary fit between the sleeve 170 and the exterior ribs 169 on the plurality of SCR catalysts 164, the catalysts can be positioned into concentric alignment with the sleeve axis 172.

In an embodiment, the axial length of the sleeves 170 between the first end 174 and second end 176 can be sized to be generally coextensive with the combined length of the plurality of SCR catalysts 164. For example, in the illustrated embodiment, the sleeve 170 can receive a first catalyst 186 and a second catalyst 188 that are arranged and axially inserted into the sleeve, though different numbers of catalysts may be included. The first catalyst 186 can be inserted first and slid or pushed toward the first end 174 and the second catalyst 188 can be inserted second and oriented toward the second end 176. Once inserted, the plurality of SCR catalysts 164 are arranged adjacent to each other in a stacked, abutting relationship and can be substantially coextensive with the length of the sleeve 170.

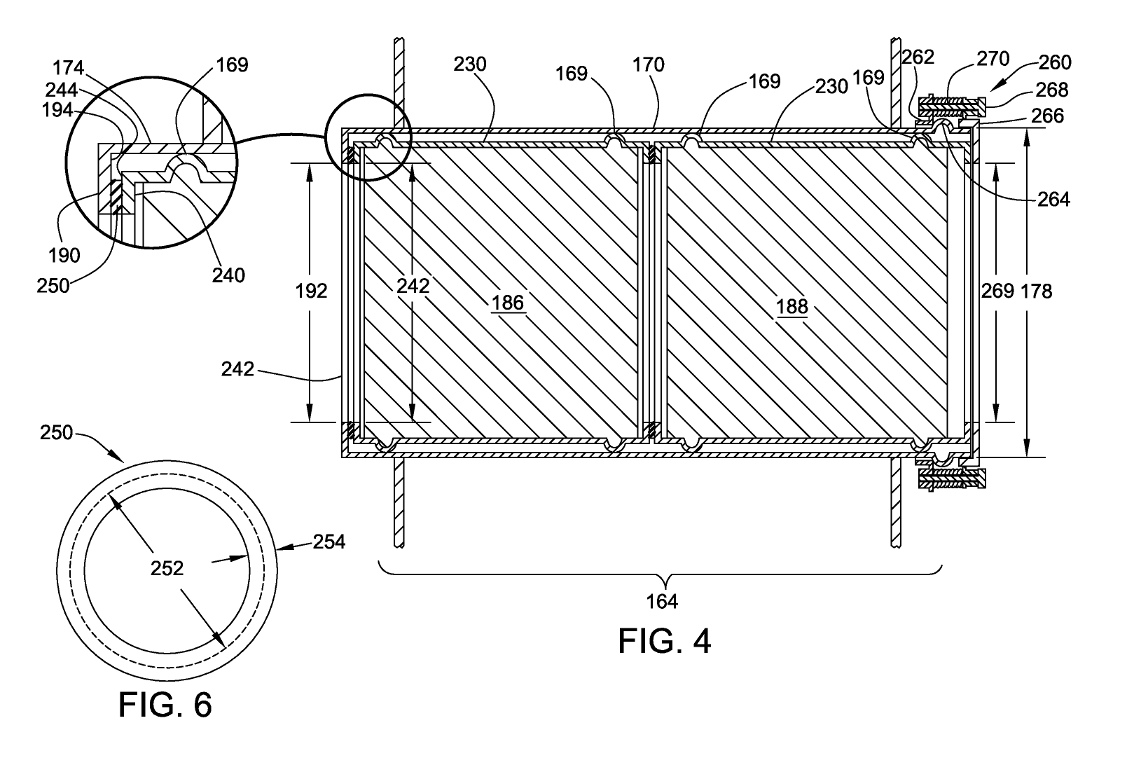

Referring to FIG. 4, to prevent the plurality of catalysts from being pushed out the first end 174 during insertion, the sleeve 170 can include a stop flange 190 formed at the first end. The stop flange 190 can have a flange-like shape and can extend radially inward and depend perpendicularly toward the sleeve axis 172. In those embodiments in which the sleeve 170 is provided as a thin-walled tube, the stop flange 190 can be formed by bending or crimping the first end 174 inwardly. The stop flange thereby delineates a stop diameter 192 that is less than the sleeve diameter 179 associated with the opening 178 and the catalyst diameter 168 associated with the plurality of SCR catalysts 164. The inwardly crimped stop flange 190 thus includes a flat, annular abutment surface 194 extending between the sleeve diameter 179 and inner stop diameter 192 that is oriented perpendicularly to the sleeve axis 172. In other embodiments, the stop flange 190 can be formed as a plurality of intermittently spaced teeth depending radially inward toward the sleeve axis. In such an embodiment, the abutment surface would not be a continuous annulus. Accordingly, when the plurality of SCR catalysts 164 are axially inserted into the sleeve 170 toward the first end 174, the first catalyst 186 will abut against the stop flange 190 preventing further displacement of the catalyst along the sleeve axis 172. Even with the first catalyst positioned against the stop flange 190, the opening defined by the stop diameter 192 allows exhaust gasses to flow to and from the catalysts and into and out of the sleeve 170.

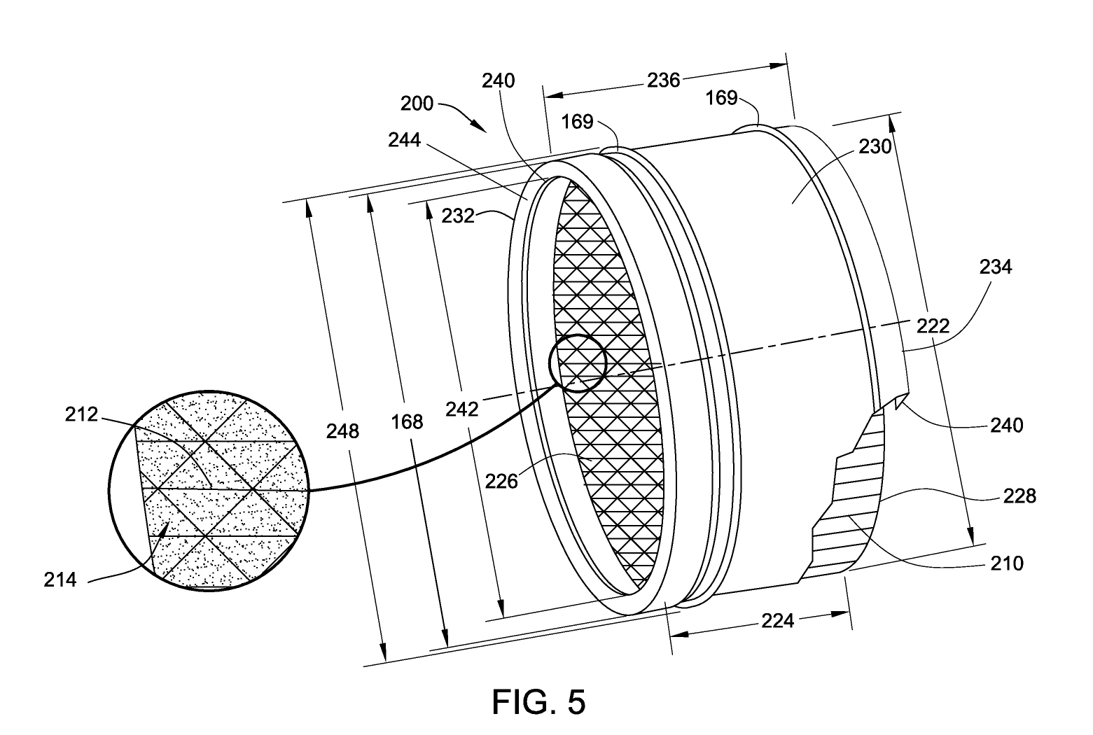

To abut the first inserted catalyst 186 against the stop flange 190, the catalyst can include a structure generally corresponding to the stop flange 190. For example, referring to FIG. 5, there is illustrated an embodiment of an aftertreatment brick and, specifically, a SCR catalyst 200 that can perform the SCR reaction. The SCR catalyst 200 can be a two-piece design including an internal substrate matrix 210 and an outer mantle 230. The internal substrate matrix 210 can include the catalytic material or coating 214 that performs the chemical reaction disposed on a structure of triangular lattice, honeycomb lattice, metal mesh substrate, or similar thin-walled support structure 212. Such designs for the support structures enable the exhaust gas/reductant agent mixture to pass into and through the SCR catalyst 200. Any suitable material can be used for the support structure 212 including, for example, ceramics, titanium oxide, or copper zeolite. Catalytic coatings 214 can include various types of metals such as vanadium, molybdenum and tungsten. The catalytic coating 214 can be deposited on the support structure 212 by any suitable method including, for example, chemical vapor deposition, adsorption, powder coating, spraying, etc. In other embodiments, the substrate matrix can be made entirely from a catalytic material. In the illustrated embodiment, the substrate matrix 210 can have a cylindrical shape corresponding to the sleeve and delineating both a longitudinal brick axis 218 and a matrix diameter 222. The substrate matrix 210 can also have a length 224 between a first circular face 226 and an opposite second circular face 228.

To protect the support structure 212, a tubular mantle 230 can be generally disposed around the substrate matrix 210. The tubular mantle 230 can be made of a thicker or more rigid material than the thin-walled support structure 212, such as aluminum or steel. For example, the mantle may be about 5/16 of an inch thick to provide structural rigidity to the catalyst. The outer circumference of the mantle 230 may correspond to the catalyst diameter 168 sized for accommodation in the sleeves. The tubular mantle 230 can have a shape complementary to that of the substrate matrix 210 that, in the illustrated embodiment, is generally cylindrical and concentric to the brick axis 218. The cylindrical mantle 230 can extend between a first circular rim 232 and a second circular rim 234 that correspond in diameter to the catalyst diameter 168. Formed on the first and/or second rims 232, 234 can be a mantle flange 240 that generally corresponding in shape and function to the stop flange in the sleeve. In particular, the mantle flange 240 can depend perpendicularly from the first and/or second rim 232, 234 radially inward toward the brick axis 218. The mantle flange 240 therefore includes a second annular abutment surface 244 that is generally perpendicular to the brick axis 218. To enable fluid communication to the substrate matrix 210 inside, the mantle flange 240 can have a flange diameter 242 that generally delineates an access to the matrix. The flange diameter 242 can be smaller than the matrix diameter 222.

In an embodiment, to produce the SCR catalyst 200, the mantle 230 can be formed from as a rectangular piece of blank material such as sheet metal or plate. To place the mantle 230 around the substrate matrix 210, the blank can be rolled into a hollow tube and the matrix inserted or stuffed therein. In another embodiment, the blank can be wrapped around a preformed substrate matrix 210. The blank can have an initial length that is longer than a corresponding length 224 of the substrate matrix. The additional length provides excess material that can be bent or crimped radially inward to form the mantle flange 240. In an embodiment, sufficient excess material can be provided so that the mantle 230 has a length 236 that is greater than the length 224 of the substrate matrix 210 and the mantle flanges 240 are thus spaced from the respective faces 226, 228 of the matrix. In the illustrated embodiment, a mantle flange 240 can be formed at each of the first and second rims 232, 234 or, in other embodiments, can be formed at only one of the rims.

In the embodiments including the exterior ribs 169, the ribs can be formed as an integral part of the mantle 230. For example, prior to rolling or warping the blank into the tubular mantle 230, protrusions that will become the exterior ribs 169 can be formed or pressed into the blank. The exterior ribs 169 can have a curved or hemispherical cross-section and can protrude radially outward with respect to the brick axis 218. In the illustrated embodiment, the exterior ribs 169 can continuously circumscribe the brick axis 218 but in other embodiments each rib could be formed as a plurality of intermittently-spaced protrusions. Because the exterior ribs 169 protrude in a radially outward direction, the ribs can establish a rib diameter 248 that is larger than the catalyst diameter 168 associated with the exterior surface of the mantle 230 and is generally equal to the sleeve diameter to establish a sliding fit between the catalyst and the sleeve. In the illustrated embodiment, two exterior ribs 169 are included with one each oriented toward the first and second rims 232, 234 respectively. In other embodiments, the exterior ribs can be formed as separate pieces that are attached to the exterior of the mantle by welding or the like. As described below, the sliding fit can facilitate alignment and assembly of the components of the aftertreatment module.

Referring back to FIG. 3, when the first SCR catalyst 186 is inserted into the sleeve 170, the complementary shape between the catalyst and sleeve will align the concentrically catalyst with the sleeve axis 172. The exterior ribs 169 disposed around the mantle can facilitate alignment. In the embodiments where the exterior ribs 169 completely circumscribe the first SCR catalyst 186 and have a rib diameter 248 roughly equal to the sleeve diameter 179, the ribs can be in continuous contact with the interior surface of the tubular sleeve 170. Thus, the first SCR catalyst 186, the sleeve 170 are concentrically aligned with each other. As the first SCR catalyst 186 is moved or pushed toward the first end 174 of the sleeve 170, the mantle flange 240 will be in opposing positional relation to the stop flange 190. Moreover, to ensure the mantle flange 240 and the stop flange 190 are in an overlapping or co-extensive position, the flange diameter 242 and the stop diameter 192 can have corresponding or similar dimensions. Accordingly, once the first SCR catalyst 186 is fully inserted, the mantle flange 240 will abut the stop flange 190 preventing further axial displacement and retaining the plurality of catalysts 164 in the sleeve 170.

In an embodiment, to provide a seal between the abutting stop flange 190 and mantle flange 240, which may be a metal-on-metal contact, a gasket 250 can be disposed between the flanges. Referring to FIG. 6, there is illustrated an example of a suitable gasket 250 for sealing between the sleeve and the catalyst. The gasket 250 can be annular in shape, similar to the stop and mantle flanges 190, 240, and can have an average gasket diameter 252 that is dimensionally between the size of the stop and flange diameters 192, 242 and the sleeve diameter 179. Further, the gasket 250 may have an annular thickness 254 due to the annular shape. The gasket 250 is therefore appropriately sized to fit within the sleeve 170. In an embodiment, the gasket 250 can be made from a woven metal mesh, such as stainless steel, impregnated or coated with another material such as graphite which may have a resilient or compliant consistency. However, in other embodiments, the gasket can be made from other materials such as a resilient, compliant elastomer.

Referring back to FIG. 4, when the gasket 250 is placed between the stop flange 190 and the mantle flange 240, the gasket can be generally co-extensive with the first annular abutment surface 194 on the stop flange and the second annular abutment surface 244 on the mantle flange due to the corresponding sizes and shapes. Moreover, the concentric alignment between the sleeve 170 and the first SCR catalyst 186 resulting in part from the exterior ribs 169 helps ensure that the first and second annular abutment surfaces 194, 244 and the annular gasket 250 radially overlap and can be adjacently stacked against each other. The length of the first and second annular abutment surfaces and the thickness 254 of the gasket can be generally co-extensive to increase the surface area of contact between the components. A possible advantage of increasing the surface contact between the flat first and second annular abutment surfaces 194, 244 on the stop flange 190, the mantle flange 240 and the gasket 250 is an improved distribution of compressive forces between these components. Because the components can better distribute the load, they can better resist deformation or distortion such as, for example, tearing of the gasket 250.

To generate the compressive forces that are transferred through the plurality of SCR catalysts 164, which assist holding the plurality of SCR catalysts 164 in the sleeve 170, a suitable retention mechanism 260 can be attached proximate the sleeve opening 178. In the illustrated embodiment, the retention mechanism 260 can include a first ring 262 disposed exteriorly around the second end 176 of the sleeve 170. The first ring can be permanently fixed to the second end 176, by welding or the like, or it can be free floating and retained on the first end by, for example, a circumferential bead 264. A second ring 266 can be attached to the first ring 262 by, for example, a plurality of threaded fasteners 268, such as bolts or the like, that can be received into corresponding threaded holes on either or both of the rings. In an embodiment, the threaded fasteners 268 can be inserted through compression bodies 270 that are disposed between the first and second rings 266, 268. The second ring 266 can delineate an inner ring diameter 269 that is slightly less than the sleeve diameter 179 so that a portion of the second ring extends across the sleeve opening 178. The inner ring diameter 269 can also be smaller than the catalyst diameter 168 so that the second ring 266 can contact a portion of the second catalyst 188 and retain the catalyst at the sleeve opening 178. Moreover, due to the axially co-extensive lengths of the sleeve 170 and the plurality of SCR catalysts 164, the second ring 266 can contact and press against the second SCR catalyst 188 thereby directing a compressive force in the direction of the sleeve axis 172. The compressive force can in part be imparted onto the gasket 250 at the first end 174. Of course, in other embodiments, other suitable types and styles of retention mechanisms can be used to block the sleeve opening 178.

### INDUSTRIAL APPLICABILITY

As stated above, the present disclosure is directed to assembling an aftertreatment module that may include one or more removable aftertreatment bricks for the treatment of exhaust gasses in a large exhaust aftertreatment system 120 or CEM such as illustrated in FIG. 1. While the disclosure has been described in specific embodiments an SCR system utilizing SCR catalysts, it will be appreciated that disclosure applies to other types of aftertreatment systems using different types of aftertreatment bricks such as diesel oxidation catalysts, diesel particulate filters and the like. Further, although the described embodiments are generally cylindrical in shape, different complementary shapes of the components are contemplated.

Referring to FIG. 4, to assemble the aftertreatment module, a sleeve 170 or plurality of sleeves are provided to accommodate the aftertreatment bricks. A first aftertreatment brick, in particular, a first SCR catalyst 186 is inserted through a sleeve opening 178 in the second end 176 of the sleeve and axially moved or pushed toward the first end 174. To enable insertion, the sleeve diameter 179 can be larger than the catalyst diameter 168 associated with the first SCR catalyst 186. To concentrically align the catalyst with the sleeve, the exterior ribs 169 which can be co-dimensional with the sleeve diameter 179 can be in continuous contact with the interior surface of the sleeve. A second SCR catalyst 188 can also be inserted into the sleeve 170, in part, to push the first SCR catalyst 186 toward the first end 174. As the first SCR catalyst 186 reaches the first end 174, it will encounter and abut against the stop flange 190 formed at the first end thereby preventing further displacement of the first SCR brick with respect to the sleeve axis 172. Contact between the first SCR catalyst 186 and the stop flange 190 occurs because the catalyst diameter 168 is larger that the stop diameter 192.

To seal against exhaust gasses leaking between the sleeve 170 and the first SCR catalyst 186, a gasket 250 can be disposed between the stop flange 190 and a corresponding mantle flange 240 formed on the first SCR catalyst. In various alternative embodiments, the gasket 250 can be pre-attached or pre-fixed to the mantle flange 240 or to the stop flange 190. Alignment between the mantle flange 240, the stop flange 190, and the gasket 250 is facilitated by contact between the exterior ribs 169 disposed about the first SCR catalyst 186 and the interior surface of the sleeve 170 which concentrically locates the catalyst with the sleeve and sleeve axis 172. The stop and mantle flanges 190, 240 may include first and second annular abutment surfaces 194, 244 that spread out or distribute the compression forces across a larger contact area to help prevent physically destructive deformation of the components. To further facilitate sealing, a second gasket 250 can be disposed between the first SCR catalyst 186 and the second SCR catalyst 188, although different types or styles of gaskets could be used.

To retain the plurality of catalysts 164 together in the sleeve 170, a retention mechanism 260 is attached to the second end 176 to partially obstruct the sleeve opening 178. The retention mechanism 260 can also contact and urge the second SCR catalyst 188 axially toward the first end 174 to direct a compressive force against the gasket 250 between the stop flange 190 and the mantle flange 240. To enable removal of the plurality of SCR catalysts 164 and disassembly of the module, for example, to service or replace the catalysts, the retention mechanism 260 can be detached from the second end 176 by, for example, the removable threaded fasteners.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An aftertreatment module comprising:
at least one sleeve arranged in a sleeve bundle, the sleeve extending between a first end and a second end along a sleeve axis, the first end including a stop flange generally perpendicular to the sleeve axis and the second end including an sleeve opening;
at least one aftertreatment brick axially inserted into the sleeve through the sleeve opening, the aftertreatment brick including a substrate matrix and a mantle disposed around the substrate matrix, the mantle including a mantle flange to abut the stop flange and an exterior rib configured to contact an interior surface of the sleeve; and
a gasket disposed between the stop flange and the mantle flange.

2. The aftertreatment brick of claim 1, wherein the interior surface of the sleeve and the mantle are cylindrical, and the gasket is annular.

3. The aftertreatment brick of claim 2, wherein the sleeve and the aftertreatment brick are concentric to each other.

4. The aftertreatment module of claim 3, wherein the exterior rib circumscribes the mantle.

5. The aftertreatment module of claim 4, wherein the exterior rib is in continuous contact with the interior surface of the sleeve to concentrically align the aftertreatment brick and the sleeve axis.

6. The aftertreatment module of claim 5, further comprising a second aftertreatment brick axially inserted into the sleeve through the sleeve opening and positioned proximate the second end.

7. The aftertreatment module of claim 1, wherein the stop flange includes a first annular abutment surface and the mantle flange includes a second annular abutment surface, the first annular abutment surface and the second annular abutment surface perpendicular to the sleeve axis.

8. The aftertreatment module of claim 7, wherein the gasket comprises woven metal and graphite.

9. The aftertreatment module of claim 8, wherein the second annular abutment surface of the mantle flange delineates a flow opening establishing fluid communication with the substrate matrix.

10. The aftertreatment brick of claim 2, wherein the sleeve opening includes a sleeve diameter, the aftertreatment brick includes a brick diameter; the stop flange includes a stop diameter, and the mantle flange includes a flange diameter, wherein the sleeve diameter is greater than the brick diameter that is greater than the stop diameter that is greater than or substantially equal to the flange diameter.

11. A method of assembling an aftertreatment module comprising:
providing a sleeve having a first end and a second end disposed along a sleeve axis, the first end including a stop flange oriented perpendicular to the sleeve axis;
disposing a gasket inside the sleeve proximate to the stop flange;
providing an aftertreatment brick having a substrate matrix and a mantle disposed around the substrate matrix, the mantle including a mantle flange;
axially inserting the aftertreatment brick through a sleeve opening in the second end of the sleeve and toward the first end of the sleeve; and
abutting the mantle flange against the gasket and the stop flange.

12. The method of claim 11, wherein the mantle further includes an exterior rib.

13. The method of claim 12, further comprising concentrically aligning the aftertreatment brick with the sleeve axis by contact between the exterior rib and an interior surface of the sleeve.

14. The method of claim 13, wherein the interior surface of the sleeve and the mantle of the aftertreatment brick are cylindrical tubes.

15. The method of claim 14, wherein the stop flange includes a first annular abutment surface, and the mantle includes a second annular abutment surface, the first and second annular abutment surfaces substantially perpendicular to the sleeve axis.

16. The method of claim 15, wherein the sleeve opening includes a sleeve diameter, the aftertreatment brick includes a brick diameter; the stop flange includes a stop diameter, and the mantle flange includes a flange diameter, wherein the sleeve diameter is greater than the brick diameter that is greater than the stop diameter that is greater than or substantially equal to the flange diameter.

17. The method of claim 11, further comprising inserting a second aftertreatment brick through the sleeve opening in the second end of the sleeve.

18. An aftertreatment brick comprising:
a cylindrical substrate matrix delineating a brick axis;
a tubular mantle disposed around the cylindrical substrate matrix and concentric to the brick axis; and
an exterior rib generally circumscribing the tubular mantle, the exterior rib adapted to contact an interior surface of a tubular sleeve having a corresponding shape to concentrically align the aftertreatment brick with respect to the sleeve.

19. The aftertreatment brick of claim 18, wherein the tubular mantle is made of a sheet material and the exterior rib is formed into the sheet material.

20. The aftertreatment brick of claim 19, wherein the tubular mantle includes a first rim and a second rim disposed at axially opposite ends of the aftertreatment brick, the tubular mantle further including a second exterior rib, the first exterior rib and the second exterior rib oriented toward the first rim and the second rim respectively.
